(19) United States
(12) Patent Application Publication
(10) Pub. No.: US 2020/0306609 A1
(43) Pub. Date: Oct. 1, 2020

(54) BOXING FITNESS DEVICE WITH CLOUD TECHNOLOGY AND DETECTION METHOD THEREOF

(71) Applicant: STRENGTH MASTER FITNESS TECH. CO., LTD., Changhua County (TW)

(72) Inventor: SHU-YAO WU, CHANGHUA COUNTY (TW)

(21) Appl. No.: 16/362,980

(22) Filed: Mar. 25, 2019

(51) Int. Cl. A63B 69/32; A63B 69/16; A63B 22/02; A63B 22/04; A63B 22/06; H04M 1/725

(52) U.S. Cl. CPC A63B 69/32; A63B 69/16; A63B 22/02; A63B 2225/50; A63B 22/0664; H04M 1/7253; A63B 2220/53; A63B 22/04

(57) ABSTRACT

A boxing fitness device with cloud technology and a detection method thereof are provided. The boxing fitness device with cloud technology includes a boxing board, a storage device, an indicating device, a plurality of sensing devices, a first wearable device, a second wearable device, and an operational unit. The notifying device may be disposed on the boxing board. The sensing device may be connected with the boxing board. The operational unit may electrically be connected to the sensing device. in combination with different songs in the storage device, boxing and exercising may be performed to achieve a variety of exercise modes. The purpose of entertainment may also be achieved by converting the inputted music into a hitting indication or converting the signal detected from hitting into music including a scale, rhythm, volume, melody, and tone.

### BACKGROUND OF THE INVENTION

### 1. Field of the Invention

The present invention provides a boxing fitness device with cloud technology and detection method thereof, more particularly to a boxing fitness device with cloud technology and detection method thereof able to detect a user's punch, combine with music to realize a variety of exercise modes, and provide the function of connecting different boxing fitness devices to perform ranking.

### 2. Description of the Related Art

Conventional aerobic exercise devices typically focus on training a certain part of a user's body. For example, treadmills, spinning bikes, etc., which emphasize on most of the muscles in the user's lower body. Few exercise devices can be used to train all muscles in the user's lower body. In addition, since most devices work independently, it is difficult to interact with and encourage each other even in a fitness center where many people exercise at the same time, making it boring after a long period of exercise. Moreover, the modes that conventional exercise devices can provide are limited. If the exercise devices are to be used to achieve the effects of exercising and entertainment, the effects are expected to be unsatisfactory. Therefore, there is a need for a boxing fitness device and a detection method thereof to solve the above-mentioned conventional problems.

### SUMMARY OF THE INVENTION

The present invention is used to detect a user's punch to train the coordination ability of a user's hands and eyes and the accuracy of the motion control and provide connection between each of the boxing fitness devices to perform ranking Moreover, a group course may be led by a coach so that users may encourage each other to improve the exercising atmosphere. Furthermore, in combination with different songs in the storage device, boxing and exercising may be performed to achieve a variety of exercise modes. The purpose of entertainment may also be achieved by converting the inputted music into a hitting indication or converting the signal detected from hitting into music including a scale, rhythm, volume, melody, and tone.

Based on the purposes stated above, the present invention provides a boxing fitness device with cloud technology, including a boxing board, a storage device, a processing unit, an operational unit, a notifying device, a sensing device, a first wearable device, and a second wearable device. The storage device stores one or more of a scale, rhythm, volume, melody, and tone included in at least one song track. The processing unit obtains one or more of a scale, rhythm, volume, melody, and tone included in at least one song track, and operates to generate a setting signal according to one or more of a scale, rhythm, volume, melody, and tone included in the song track. The operational unit is electrically connected to the processing unit and generates a first control signal according to the setting signal. The notifying device is disposed on the boxing board and sends a notifying message according to the first control signal. The sensing device is connected to the boxing board, senses a user hitting the boxing board according to the notifying message, and generates a boxing sensing signal. Wherein, the operational unit is electrically connected to the sensing device and the notifying device and generates a second control signal according to the boxing sensing signal. The notifying device sends a result message according to the second control signal.

Preferably, the boxing fitness devices may include a structure combined with a treadmill, a spinning bike, a fan bike, an exercise bike, a stepper, or an elliptical trainer.

Preferably, a first wearable device and a second wearable device are further included. The sensing device senses the first wearable device or the second wearable device and generates a first sensing signal or a second sensing signal when the first wearable device or the second wearable device approaches or contacts the boxing board.

Preferably, the user wears the first wearable device or the second wearable device on hands, and approaches or contacts the boxing board with the first wearable device or the second wearable device by a boxing posture. The processing unit further includes operating to generate one or more of the wearable device moving speed, the wearable device contact strength, the wearable device contact time, and the wearable device sensed frequency according to the second control signal.

Preferably, the storage device includes a cloud platform, a cell phone, a tablet PC, a smart watch, a wristband, USB, a memory card, or a console installed on the boxing fitness device. The processing unit further includes operating to generate the song track according to one or more of the wearable device moving speed, the wearable device contact strength, the wearable device contact time, and the wearable device sensing frequency and uploading the song track to the storage device which includes an editing module which edits one or more of a scale, rhythm, volume, melody, and tone included in the song track.

Preferably, the notifying device generates an indicating message of a boxing target according to the first control signal, and the indicating message may be a picture, color, an image, or a sound. When a boxing rate of the user hitting the boxing targets decreases to a value for a set time, the operational unit reduces a generating speed of the indicating message and slows down the playing rhythm of the song track; when a boxing rate of the user hitting the boxing target increases to or maintains a value for a set time, the operational unit raises the generating speed of the indicating message and speeds up the playing rhythm of the song track.

Preferably, the detecting device is disposed in the first wearable device or the second wearable device to detect a user's physical information including pulse, blood oxygen concentration, body temperature, blood pressure, and the like, and generate a signal.

Preferably, the operational unit operates to generate the approaching or contact data according to the first sensing signal and the second sensing signal. The operational unit further generates boxing data having scores according to the first sensing signal or the second sensing signal. The processing unit may also communicate with at least another boxing fitness device. The processing unit receives a plurality of boxing data of the plurality of boxing fitness devices and performs ranking and displaying.

Preferably, the first wearable device and the second wearable device differ in polarities, electrical properties, identification codes, or light wavelengths, or one of the first wearable device and the second wearable device has a sensed end and the other does not have a sensed end. The sensing device may determine whether the user approaches or contacts the boxing board with the left or right hand according to the polarities, electrical properties, identification codes or light wavelengths of the first wearable device and the second wearable device, or according to whether to have a sensing signal. The first wearable device and the second wearable device respectively generate the first signal and the second signal when approaching or contacting the boxing board, and the sensing device may determine whether the user approaches or contacts the boxing board with the left or right hand according to the first signal and the second signal.

Preferably, the sensing device includes a power sensor, a pressure sensor, a magnetic sensor, a photoelectric sensor, an image sensor, an ultrasonic sensor, and the like.

Preferably, the boxing board includes a plurality of boxing zones, and the plurality of boxing zones respectively represent one of a scale, rhythm, volume, melody, and tone corresponding to the song track.

Preferably, the sensing device senses the boxing sensing signal of the boxing board, and one or more of a scale, rhythm, volume, melody, and tone of the corresponding song track may be generated by the processing unit, which may be stored as a song track via the storage device.

Based on the purposes stated above, the present invention further provides a method of converting hitting into music, including the following steps:

sending a respectively setting a plurality of boxing zones included in a boxing board as musical notes corresponding to music;

sensing a hit from a user hitting the boxing board by a sensing device connected to the plurality of boxing zones, and generating a boxing sensing signal;

converting the hit into the corresponding musical notes by a processing unit according to the boxing sensing signal;

generating rhythm or high and low sounds corresponding to a height or length of the boxing sensing signal by an operational unit;

recording the generated musical notes and the rhythm or high and low sounds corresponding thereof within a period of time by a storage unit; and

converting the hit into a song track.

### BRIEF DESCRIPTION OF THE DRAWINGS

FIG. 1 is a configuration schematic diagram of the boxing fitness device according to an embodiment of the present invention.

FIG. 2 is a cross-sectional diagram of the boxing fitness device according to an embodiment of the present invention.

FIG. 3 is a first implementation diagram of the boxing fitness device according to an embodiment of the present invention.

FIG. 4 is a second implementation diagram of the boxing fitness device according to an embodiment of the present invention.

FIG. 5 is a third implementation diagram of the boxing fitness device according to an embodiment of the present invention.

FIG. 6 is a flow chart of the detection method of the boxing fitness device according to an embodiment of the present invention.

### DESCRIPTION OF THE PREFERRED EMBODIMENTS

To facilitate the review of the technique features, contents, advantages, and achievable effects of the present invention, the embodiments together with the attached drawings are described below in detail. However, the drawings are used for the purpose of indicating and supporting the specification, which may not depict the real proportion of elements and precise configuration in the implementation of the present invention. Therefore, the depicted proportion and configuration of the attached drawings should not be interpreted to limit the scope of implementation of the present invention.

The embodiments of the boxing fitness device and the detection method thereof in the present invention are explained with reference to the related figures. For ease of understanding, the same elements in the following embodiments are described by using the same symbols.

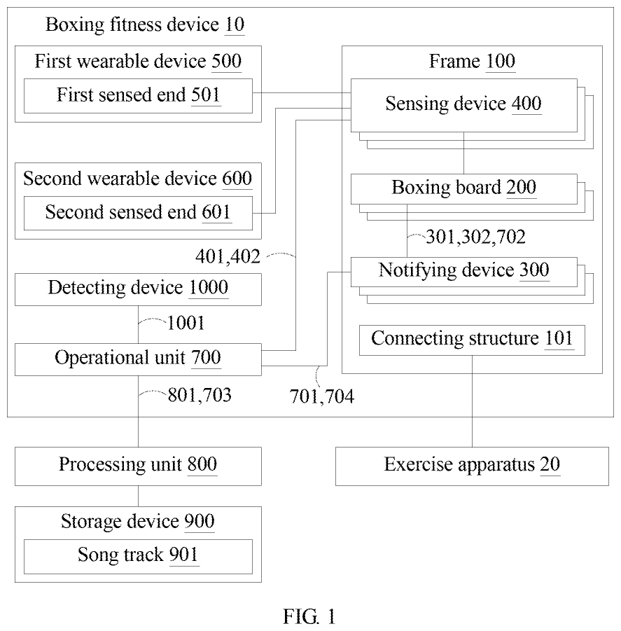

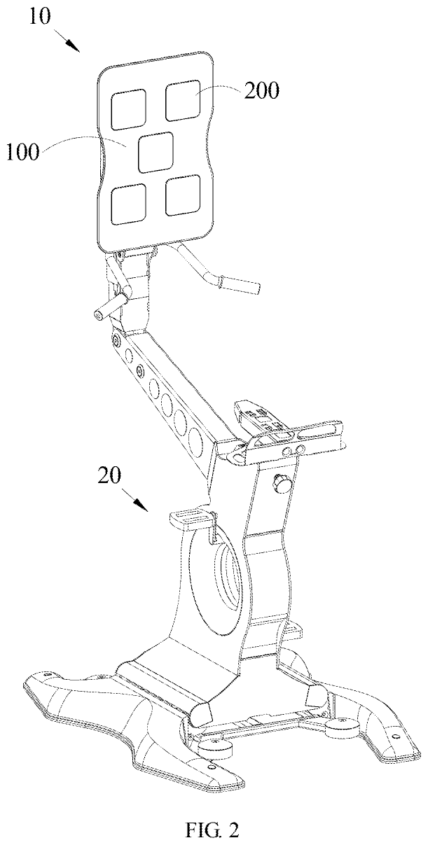

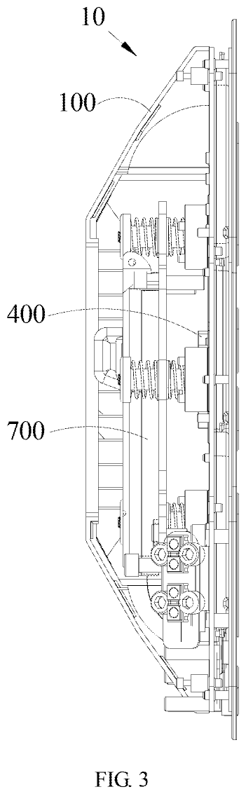

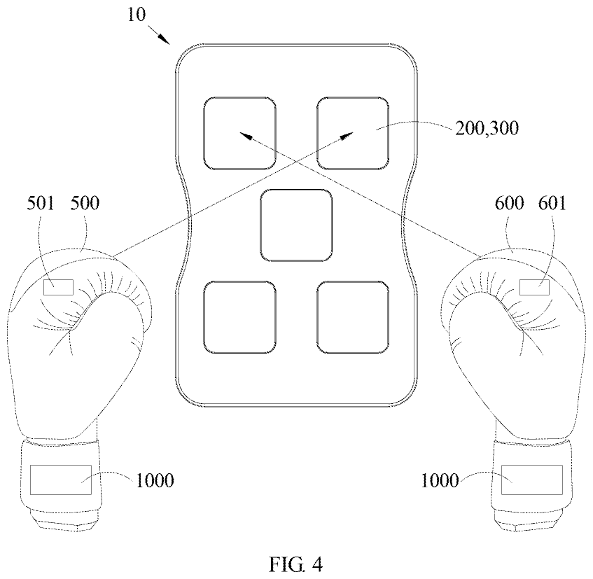

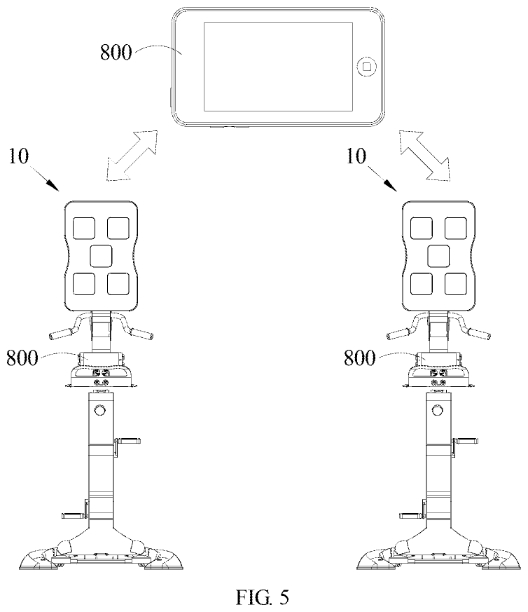

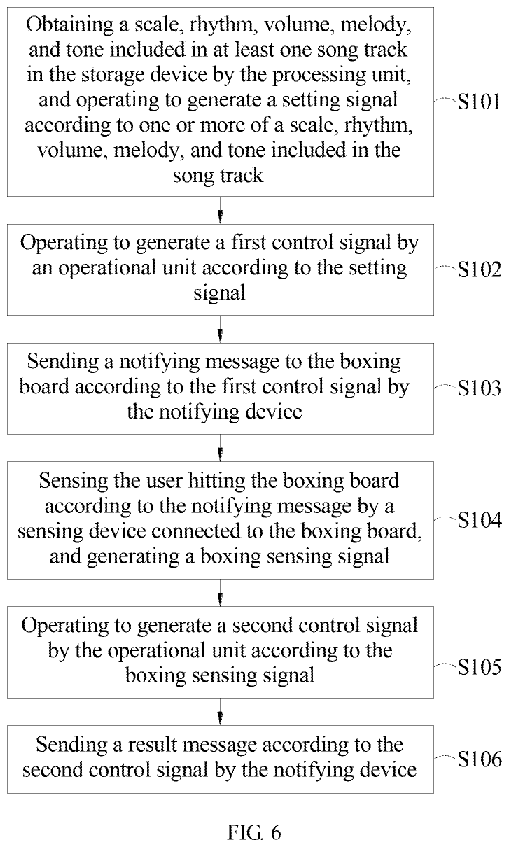

Please refer to FIGS. 1 to 6, respectively illustrating the configuration schematic diagram, the cross-sectional diagram, the first implementation diagram, the second implementation diagram, the third implementation diagram, and the flow chart of the detection method of the boxing fitness device according to the embodiments of the present invention.

The boxing fitness device 10 in the present invention may include a frame 100, a boxing board 200, a notifying device 300, a sensing device 400, a first wearable device 500, a second wearable device 600, an operational unit 700, a storage device 900, and a detecting device 1000.

The boxing board 200 is disposed in the frame 100. In an embodiment, the frame 100 may include a rigid plastic. The boxing board 200 may include elastic materials, such as silicone rubber, rubber, etc., to absorb the impact force when being hit, which reduces the impact force by hands and prevents the hands from injury. In addition, the boxing board 200 may include a plurality of boxing zones.

The storage device 900 may store one or more of a scale, rhythm, volume, melody, and tone included in at least one song track 901. In an embodiment, the song track 901 may be dance music, folk songs, rap songs, etc. In an embodiment, the storage device 900 further includes a cloud platform, a cell phone, a tablet PC, a smart watch, a wristband, USB, a memory card, or a console installed on the boxing fitness device, and the storage device 900 may also include an editing module. The editing module may be used to edit one or more of a scale, rhythm, volume, melody, and tone included in the song track 901. In addition, the plurality of boxing zones respectively represent one of a scale, rhythm, volume, melody, and tone corresponding to the song track.

The processing unit 800 may electrically be connected to the storage device 900 to obtain one or more of a scale, rhythm, volume, melody, and tone included in at least one song track 901 and operate to generate a setting signal 801 according to one or more of a scale, rhythm, volume, melody, and tone included in the song track 901. In an embodiment, the processing unit 800 may include a system constituted by a computer, a tablet computer, a mobile phone, a projection device, and a display screen. For example, the user may download the song track 901 from the storage device 900 by using the mobile phone, and edit the plurality of song tracks 901 (i.e., changing rhythm, frequencies, or composition of the songs) to constitute the setting signal 801. In addition, the user may also upload the created song tracks 901 to the storage device 900 for other people to download.

The operational unit 700 may electrically be connected to the processing unit 800, and the operational unit 700 may generate the first control signal 701 according to the setting signal 801.

The notifying device 300 may be disposed on the boxing board 200 and send a notifying message 301 according to the control signal 701. In an embodiment, the notifying device 300 may include one or more of sounding elements, LED light emitting elements, and vibrating motors to provide one or more of messages, such as sounds, patterns, light, vibration, etc.

In an embodiment, the operational unit 700 generates the first control signal 701 by analyzing the scale, rhythm, volume, melody, and tone of the song track 901 in the setting signal 801. The notifying device 300 receives the first control signal 701 to generate an indicating message of a boxing target to notify the user to hit, and the indicating message is a picture, color, an image, or a sound. When a boxing rate of the user hitting the boxing targets decreases to a value for a set time, the operational unit 700 reduces the generating speed of the indicating message and slows down the playing rhythm of the song track 901; when a boxing rate of the user hitting the boxing target increases to or maintains a value for a set time, the operational unit 700 raises the generating speed of the indicating message and speeds up the playing rhythm of the song track. For example, when the boxing rate of the user hitting the boxing target reduces to 50% or less for 2 minutes, the operational unit 700 reduces the generating speed of the indicating lights, and slows down the playing rhythm of the song track 901. When the boxing rate of the user hitting the boxing target increases up to 80% or more for 2 minutes, the operational unit 700 raises the generating speed of the indicating message and speeds up the playing rhythm of the song track 901.

The sensing device 400 is connected to the boxing board 200 and senses a user hitting the boxing board 200 according to the notifying message 301 and generates a boxing sensing signal. The sensing device 400 includes a power sensor, a pressure sensor, a magnetic sensor, a photoelectric sensor, an image sensor, an ultrasonic sensor, and the like. In an embodiment, the present invention further includes a first wearable device 500 and a second wearable device 600. When the first wearable device 500 or the second wearable device 600 approaches or contacts the boxing board 200, the sensing device 400 may sense the first wearable device 500 or the second wearable device 600 and generate the boxing sensing signal. In another embodiment, the first wearable device 500 includes a first sensed end 501, and the second wearable device 600 includes a second sensed end 601. When the first wearable device 500 or the second wearable device 600 approaches or contacts the boxing board 200, the sensing device 400 may sense the first sensed end 501 or the second sensed end 601 and generate the first sensing signal 401 and the second sensing signal 402. The first sensing signal 401 and the second sensing signal 402 correspond to the above-mentioned boxing sensing signal. The user may wear the first wearable device 500 and the second wearable device 600, and approach or contact the boxing board 200 with the left or right hand, namely making hit on the boxing board 200. In an embodiment, the first wearable device 500 and the second wearable device 600 may include boxing gloves for the user to wear.

In an embodiment, the first sensed end 501 and the second sensed end 601 include an electronic marker, such as a radio frequency tag (RFID tag) in such a way that the sensing device 400 performs sensing. The electronic tag may be an active, semi-passive, or passive electronic marker according to demands in such a way that determination on whether the boxing board 200 is hit by the user's left hand or right hand is made accurately and rapidly.

In an embodiment, the sensing device 400, the first sensed end 501, and the second sensed end 601 may include a Hall magnetic sensing element. Therefore, the sensing device 400, the first sensed end 501, and the second sensed end 601 may magnetically be sensed. Moreover, the sensing device 400 may accurately aware that the boxing board 200 are approached or contacted by the first wearable device 500 or the second wearable device 600 by different magnetic changing capacities or magnetic changing methods.

In another embodiment, the first sensed end 501 and the sensed end 601 differ in polarities, electrical properties, identification codes, or light wavelengths. Therefore, the sensing device 400 may determine whether a user approaches or contacts the boxing board 200 with the left or right hand according to the polarities, the electrical properties, the identification codes, or the light wavelengths of the first sensed end and the second sensed end, namely making a hit on the boxing board 200.

In another embodiment, the first wearable device 501 and the second wearable device 601 differ in polarities, electrical properties, identification codes, or light wavelengths, or one of the first wearable device 501 and the second wearable device 601 has a sensed end and the other does not have a sensed end. Therefore, the sensing device 400 may determine whether the user approaches or contacts the boxing board with the left or right hand according to the polarities, electrical properties, identification codes or light wavelengths of the first wearable device 501 and the second wearable device 601, or according to whether to have a sensing signal, for instance, making a hit on the boxing board 200.

In addition, the first sensed end 501 and the second sensed end 601 may also respectively generate the first signal and the second signal when approaching or contacting the boxing board 200. The sensing device 400 determines whether the user approaches or contacts the boxing board 200 with the left or right hand according to the first signal and the second signal. For example, the first sensed end 501 and the second sensed end 601 respectively include a first pressure sensing unit and a second pressure sensing unit. When the user hits the boxing board 200, the first pressure sensing unit and the second pressure sensing unit may respectively generate the first signal and the second signal. Therefore, the sensing device 400 determines whether the user hits the boxing board 200 with the left or right hand according to the first signal and the second signal.

When the user approaches or contacts with the left or right hand, namely hitting the boxing board 200, the sensing device 400 may sense the first sensed end 501 and generate the first sensing signal 401. When the user approaches or contacts the boxing board 200 with the second wearable device 600, the sensing device 400 may sense the second sensed end 601 and generate the second sensing signal 402.

In an embodiment, the user wears the first wearable device 500 or the second wearable device 600 on hands and approaches or contacts the boxing board 200 with the first wearable device 500 or the second wearable device 600. The processing unit 800 further includes operating to generate one or more of the wearable device moving speed, the wearable device contact strength, the wearable device contact time, and the wearable device sensed frequency according to the second control signal. The processing unit 800 further operates to generate a song track 901 with rhythm, frequencies, volume according to one or more of the wearable device moving speed, the wearable device contact strength, the wearable device contact time, and the wearable device sensed frequency, and uploads the song track to the cloud platform of the storage device 900. For example, the processing unit 800 operates the rhythm according to the wearable device moving speed and the wearable device contact time, operates the volume according to the wearable device contact strength, and operates the frequency according to the wearable device sensing frequency. In other words, the sensing device 400 senses the boxing sensing signal of the boxing board 200, and one or more of a scale, rhythm, volume, melody, and tone of the corresponding song track 901 may be generated by the processing unit 800, which may be stored as a song track via the storage device 900.

In another embodiment, the detecting device 1000 may be disposed in the first wearable device 500 or the second wearable device 600 (e.g., at the wrist) to detect the user's physical information including pulse, blood oxygen concentration, body temperature, blood pressure, and the like, and generate a signal, generate a signal 1001 so that the user may know the exercising intensity, and calculate the amount of calories consumed. In addition, in another embodiment, the boxing fitness device 10 may also be integrated with the heart rate detecting device of the exercise apparatus 20 to obtain the information on exercising intensity and calculate the amount of calories consumed.

The operational unit 700 is electrically connected to the sensing device 400 and detecting device 1000 and operates to generate the second control signal 704 according to the boxing sensing signal or the first sensing signal 401 or the second sensing signal 402. The notifying device 300 sends a result message 302 according to the second control signal 704. For example, the notifying device 300 displays the result message 302 on the boxing rate according to the second control signal 704. In another embodiment, the operational unit 700 may operate to generate the second control signal 704 having corresponding musical scales according to the boxing sensing signal or the first sensing signal 401 and the second sensing signal 402. The notifying device 300 plays corresponding songs according to the second control signal 704 having the corresponding musical scales, thereby increasing the entertainment effect.

In an embodiment, the processing unit 800 is electrically connected to the plurality of boxing fitness devices 10 at the same time, for example, using network communication. In an embodiment, the operational unit 700 further operates to generate the boxing data 703 having scores according to the first sensing signal 401, the second sensing signal 402, and the signal 1001. The processing unit 800 receives a plurality of boxing data 703 of the plurality of boxing fitness devices 10 and performs ranking and displaying the plurality of boxing data 703. Therefore, in an embodiment, the boxing fitness device 10 in the present invention may perform multi-player connection to realize a group battle game. Each boxing fitness device 10 may convert the user's heartbeat, boxing rate, the number of pounds, and pedaling speed (The stepping rhythm may go with the songs) into the corresponding scores, generates boxing data 703, and transmits the boxing data 703 to the processing unit 800. When the processing unit 800 receives the plurality of boxing data 703, the processing unit 800 performs the ranking and displaying of the plurality of boxing data 703 to choose the champion, thus increasing the sense of excitement in the competition.

Specifically, the processing unit 800 may include a system constituted by a computer, a tablet computer, a mobile phone, a projection device, a display screen, etc., which may be adjusted according to the number of users. For example, when performing a group battle game or having a group course with many people led by a coach, each user may use the tablet computer nearby or the mobile phone to view the boxing data 703. Moreover, a large projection screen may be set in the classroom and each user's data may be projected on the projection screen to encourage each other, thus increasing the exercising atmosphere. Also, when leading a group class, the coach may send a song track to each student's fitness device in real time. This makes sure that the course content on each student's fitness device is consistent (for instance, the same hitting frequency or the same course content). In this way, each student may be scored and ranked in order and the training effect of the students may be examined. The students may also download a song track from a website to the fitness device. After converting the song track into the course content for every student, the students may be able to compete with each other with their scores being uploaded.

In an embodiment, the frame 100 further includes a connecting structure 101, which may be connected to the exercise apparatus 20. The exercise apparatus 20 may include a treadmill, a spinning bike, a fan bike, an exercise bike, a stepper, or an elliptical trainer. Therefore, the boxing fitness device 10 in the present invention may be connected to various suitable exercise apparatuses 20 so that the user may not only perform default exercises of the original exercise apparatus 20, such as jogging, stepping on the flywheel, etc., but also train the upper body by using the boxing fitness device 10 in the present invention. In addition, under the condition that the punching frequency is fast enough, the physical energy is quickly consumed and the heart rate is increased, so that the user may safely perform High Intensity Interval Training (HITT) to exercise the lactic acid system in the three major energy systems in a human body, which differs from conventional devices only helping train the aerobic system. Thus, the boxing fitness device 10 in the present invention may provide a variety of training.

Therefore, the boxing fitness device in the present invention is used to detect the user approaching or touching the boxing board 200 with the left or right hand. The detection method of the boxing fitness device 10 in the present invention includes the following steps:

S101: Obtaining a scale, rhythm, volume, melody, and tone included in at least one song track 901 in the storage device 900 by the processing unit 800, and operating to generate a setting signal 801 according to one or more of a scale, rhythm, volume, melody, and tone included in the song track 901. In an embodiment, the song track 901 may be dance music, folk songs, a rap songs, etc. The processing unit 800 may include system constituted by a computer, a tablet computer, a mobile phone, a projection device, a display screen, etc. For example, the user may download the song track 901 from the storage device 900 by using the mobile phone which operates to generate a setting signal according to one or more of a scale, rhythm, volume, melody, and tone included in the song track 901. The user may also upload the created song track 901 to the storage device 900 for other people to download.

S102: Operating to generate a first control signal 701 by an operational unit 700 according to the setting signal 801. In an embodiment, the operational unit 700 generates the first control signal 701 by analyzing the scale, rhythm, volume, melody, and tone of the song track 901 in the setting signal 801.

S103: Sending a notifying message 301 to the boxing board 200 according to the first control signal 701 by the notifying device 300. The user may approach or contact the boxing board 200 according to the notifying message 301. The user may approach or contact the boxing board 200 with the left or right hand according to the notifying message 301. Moreover, the left and right hands of the user may respectively be worn with the first wearable device 500 and the second wearable device 600. In one embodiment, the notifying device 300 receives the first control signal 701 to generate an indicating message of the boxing target to notify the user to hit.

S104: Sensing the user hitting the boxing board 200 according to the notifying message 301 by a sensing device 400 connected to the boxing board 200, and generating a boxing sensing signal. Specifically, the sensing device 400 connected to the boxing board 200 senses the first sensed end 501 of the first wearable device 500 and the second sensed end 502 of the second wearable device 600 worn by the user and respectively generates a first sensing signal 401 and a second sensing signal 402.

S105: Operating to generate a second control signal 704 by the operational unit 700 according to the boxing sensing signal. Specifically, the second control signal 704 is generated by the operational unit 700 according to the first sensing signal 401 and the second sensing signal 402.

S106: Sending a result message 302 according to the second control signal 704 by the notifying device 300. For example, the notifying device 300 displays the result message 302 showing the boxing rate according to the second control signal 704.

In another embodiment, the operational unit 700 may further operate to generate a second control signal 704 having corresponding musical scales according to the boxing sensing signal or the first sensing signal 401 and the second sensing signal 402. The notifying device 300 plays corresponding songs according to the second control signal 704 having the corresponding musical scales, thereby increasing the entertainment effect.

When the left or right hand of the user approaches or contacts the boxing board 200 where the notifying message 301 is not displayed, the operational unit 700 may control the notifying device 300 to display an error message 702 according to the first sensing signal 401 or the second sensing signal 402.

In an embodiment, the notifying device 300 displays the notifying message 301 on the boxing board 200 within a period of time, and the user may approach or contact the boxing board 200 with the left or right hand according to the notifying message 301. In addition, the sensing device 400 senses the first wearable device 500 or the second wearable device 600. For example, the notifying device 300 may display at least one notifying message 301 on the boxing board 200 within one second. The notifying pattern may be displayed within one second by using the LED light emitting elements to notify the user to approach or contact the boxing board 200. The user may use the processing unit 800 to adjust the notifying device 300 to display different notifying message 301 to change the difficulty of hitting the boxing board 200. For example, the number of notifying messages 301 may be increased in a relatively short period of time to increase the difficulty of hitting the boxing board 200.

The user may approach or contact the boxing board 200 on the side of either hand with the left or right hand, or approach or contact the boxing board 200 corresponding to the midline position of the body with either hand. If the user does not approach or contact the boxing board 200 on the opposite side, the operational unit 700 may control the notifying device 300 to display the error message 702. When the user approaches or contacts the boxing board 200 where the notifying message 301 is not displayed, the sensing device 400 may sense the first wearable device 500 or the second wearable device 600. The operational unit 700 may control the notifying device 300 to display the error message 702.

Specifically, if the user wears the first wearable device 500 on the left hand and the second wearable device 600 on the right hand, the left hand should approach or contact the boxing board 200 on the right side of the user and the right hand should approach or contact the boxing board 200 on the left side of the user. The boxing board 200 corresponding to the midline position of the user's body is approached or contacted by the first wearable device 500 or the second wearable device 600. When the user approaches or contacts the wrong boxing board 200, the operational unit 700 may control the notifying device300 to display the error message 702.

In addition, the present invention further provides a method of converting hitting into music, including the following steps: first, respectively setting a plurality of boxing zones comprised in a boxing board 200 as musical notes corresponding to music; second, sensing a hit from a user hitting the boxing board 200 by a sensing device 400 connected to the plurality of boxing zones, and generating a boxing sensing signal; third, converting the hit into the corresponding musical notes by a processing unit 800 according to the boxing sensing signal; fourth, generating rhythm or high and low sounds corresponding to a height or length of the boxing sensing signal by an operational unit 700; fifth, recording the generated musical notes and the rhythm or high and low sounds corresponding thereof within a period of time by a storage unit 900, this converting the hit into a song track 901.

Therefore, the boxing fitness device and the detection method thereof in the present invention may accurately be used to detect whether the user approaches or contacts the boxing board 200 with the correct hand. Integrated with the exercise apparatuses 20, the present invention may provide a variety of exercise modes to train the cardiopulmonary function. At least triceps, deltoid muscles, and antagonistic muscles may be trained when the user makes a punch. The core muscles may also be trained to stabilize the trunk. In addition, the muscles in a lower body may specifically be trained depending on which exercise apparatus 20 is used. For instance, different levels of training may be performed on muscles, such as quadriceps and so on to achieve the purpose of training all of the muscles in a body. In addition, since the user has to make a punch on the correct boxing board 200, it is also possible to train the coordinating ability and the controlling ability of the whole body, thereby enhancing the accuracy of the motion control. Furthermore, in combination with different songs in the storage device, boxing and exercising may be performed to achieve a variety of exercise modes. The purpose of entertainment may also be achieved by converting the inputted music into a hitting indication and converting hitting into music.

The above description is merely illustrative rather than restrictive. Any equivalent modification or alteration without departing from the spirit and scope of the present invention should be included in the appended claims.

What is claimed is:

1. A boxing fitness device with cloud technology, comprising:
a boxing board;
a storage device, storing one or more of a scale, rhythm, volume, melody, and tone comprised in at least one song track;
a processing unit, obtaining one or more of a scale, rhythm, volume, melody, and tone, and operating to generate a setting signal according to one or more of rhythm, frequencies, and left and right channel volume included in the song track;
an operational unit, electrically connected to the processing unit, and operating to generate a first control signal according to the setting signal;
a notifying device, disposed on the boxing board, and sending a notifying message according to the first control signal; and
a sensing device, respectively connected to the boxing board, sensing a user hitting the boxing board according to the notifying message, and generating a boxing sensing signal;
wherein the operational unit is electrically connected to the sensing device and the notifying device and generates a second control signal according to the boxing sensing signal; wherein the notifying device send a result message according to the second control signal;
wherein the boxing board comprises a plurality of boxing zones, and the plurality of boxing zones respectively represent one of a scale, rhythm, volume, melody, and tone corresponding to the song track.

2. The boxing fitness device with cloud technology according to claim 1, wherein the boxing fitness device further comprises a structure combined with a treadmill, a spinning bike, a fan bike, an exercise bike, a stepper or an elliptical trainer.

3. The boxing fitness device with cloud technology according to claim 1, further comprising a first wearable device and a second wearable device, wherein the sensing device senses the first wearable device or the second wearable device and generates a first sensing signal or a second sensing signal when the first wearable device or the second wearable device approaches or contacts the boxing board.

4. The boxing fitness device with cloud technology according to claim 3, wherein the user wears the first wearable device or the second wearable device on hands, and approaches or contacts the boxing board with the first wearable device or the second wearable device by a boxing posture; the processing unit further comprises operating to generate one or more of a wearable device moving speed, a wearable device contact strength, a wearable device contact time, and a wearable device sensed frequency according to the second control signal.

5. The boxing fitness device with cloud technology according to claim 4, wherein the storage device further comprises a cloud platform, a cell phone, a tablet PC, a smart watch, a wristband, USB, a memory card, or a console installed on the boxing fitness device; the processing unit further comprises operating to generate the song track according to one or more of the wearable device moving speed, the wearable device contact strength, the wearable device contact time, and the wearable device sensed frequency and uploading the song track to the storage device which comprises an editing module which edits one or more of a scale, rhythm, volume, melody, and tone comprised in the song track.

6. The boxing fitness device with cloud technology according to claim 1, wherein the notifying device generates an indicating message of a boxing target according to the first control signal to notify the user to hit, and the indicating message is a picture, color, an image, or a sound; when a boxing rate of the user hitting the boxing targets decreases to a value for a set time, the operational unit reduces a generating speed of the indicating message and slows down playing rhythm of the song track; when a boxing rate of the user hitting the boxing target increases to or maintains a value for a set time, the operational unit raises the generating speed of the indicating message and speeds up the playing rhythm of the song track.

7. The boxing fitness device with cloud technology according to claim 3, further comprising a detecting device disposed between the first wearable device or the second wearable device to detect a user's physical information comprising pulse, blood oxygen concentration, body temperature, blood pressure, and the like, and generate a signal.

8. The boxing fitness device with cloud technology according to claim 7, wherein the operational unit operates to generate boxing data having scores according to the first sensing signal or the second sensing signal; the processing unit communicates with at least another boxing fitness device, and the processing unit receives a plurality of boxing data of the plurality of boxing fitness devices and performs ranking and displaying.

9. The boxing fitness device with cloud technology according to claim 3, wherein the first wearable device and the second wearable device differ in polarities, electrical properties, identification codes, and light wavelengths, or one of the first wearable device and the second wearable device has a sensed end and the other does not have a sensed end; the sensing device determines whether a user approaches or contacts the boxing board with the left or right hand according to the polarities, the electrical properties, the identification codes, or the light wavelengths of the first wearable device and the second wearable device, or according to whether to have a sensing signal; the first wearable device and the second wearable device respectively generate a first signal and a second signal when approaching or contacting the boxing board, and the sensing device determines whether the user approaches or contacts the boxing board with the left or right hand according to the first signal and the second signal.

10. A method of converting hitting into music, comprising the following steps:
respectively setting a plurality of boxing zones comprised in a boxing board as musical notes corresponding to music;
sensing a hit from a user hitting the boxing board by a sensing device connected to the plurality of boxing zones, and generating a boxing sensing signal;
converting the hit into the corresponding musical notes by a processing unit according to the boxing sensing signal;
generating rhythm or high and low sounds corresponding to a height or length of the boxing sensing signal by an operational unit;
recording the generated musical notes and the rhythm or high and low sounds corresponding thereof within a period of time by a storage unit; and
converting the hit into a song track.
